(19) United States
(12) Patent Application Publication
(10) Pub. No.: US 2017/0039140 A1
(43) Pub. Date: Feb. 9, 2017

(54) NETWORK STORAGE DEVICE FOR USE IN FLASH MEMORY AND PROCESSING METHOD THEREFOR

(71) Applicant: GIGADEVICE SEMICONDUCTOR (BEIJING) INC., Beijing (CN)

(72) Inventor: Rongzhen ZHU, Beijing (CN)

(73) Assignee: GIGADEVICE SEMICONDUCTOR (BEIJING) INC., Beijing (CN)

(21) Appl. No.: 15/303,229

(22) PCT Filed: Sep. 26, 2014
(86) PCT No.: PCT/CN2014/087500

§ 371 Date: Oct. 11, 2016

(30) Foreign Application Priority Data
Aug. 28, 2014 (CN) 201410433018.0

(51) Int. Cl. G06F 12/10; H04L 29/06; H04L 29/08

(52) U.S. Cl. CPC G06F 12/10; H04L 67/1097; H04L 67/42; G06F 2212/1041; G06F 2212/154; G06F 2212/65; G06F 2212/2022

(57) ABSTRACT

A network storage device for use in flash memory and a processing method therefor. A network storage system for use in flash memory specifically comprises: a flash memory array device and an application server The application server comprises: a flash memory array management module used for converting, on the basis of organizational information of the flash memory array device, logical address of a data read/write request coming from a client into a physical address of the flash memory array device and converting, on the basis of the physical address, an original device read/write request into a device read/write request directed at the flash memory array device, where the device read/write request directed at the flash memory array device arrives at the flash memory array device via a network. This allows an increased capacity of network storage and increased degree of convenience of network storage.

### CROSS REFERENCE TO RELATED APPLICATIONS

This application is a continuation of International Application No. PCT/CN2014/087500, filed on Sep. 26, 2014, which is based upon and claims priority to Chinese Patent Application No. 201410433018.0, filed on Aug. 28, 2014, the entire contents of which are incorporated herein by reference.

### TECHNICAL FIELD

The present disclosure relates to the field of storage technologies, and in particular, to a network storage system for use in flash memory, an application server and a flash memory access method.

### BACKGROUND

As a brand-new memory device emerged in recent years, an SSD (Solid State Disk) generally uses a flash memory (FLASH) as a memory medium and is not provided with a mechanical rotation apparatus. Therefore, the SSD is high in read/write performance, powerful in shock resistance and low in power supply overhead and so on, and is widely used in various fields.

As a technology for providing a data storage service for a user by using a memory device of a network server, a network storage technology is large in storage capacity, high in stability and high in reliability, and thus can provide excellent storage services for users.

At present, an SSD is used as a memory device in a growing number of network storage technologies. For example, referring to FIG. 1 which illustrates schematic structural diagram of a network storage system for use in SSD, which specifically may include a client 101, a NAS (Network Attached Storage) server 102 and an SSD 103, where the NAS server 102 is connected to the SSD 103 via a SATA (Serial Advanced Technology Attachment) or PCIE (Peripheral Component Interconnection Express) general interface.

However, the foregoing general interfaces are prone to wear due to plug use for many times, which may cause a failed connection between the NAS server 102 and the SSD 103.

Furthermore, the SSD 103 is limited in storage capacity, which is the biggest bottleneck in improving massive storage capacity for network storage.

### SUMMARY

A technical problem to be solved by embodiments of the present disclosure is to provide a network storage system for use in flash memory, an application server and a flash memory access method, which can improve capacity of network storage and increase convenience for network storage.

To solve the foregoing problem, the present disclosure discloses a network storage system for use in flash memory, including: a flash memory array device and an application server, where the application sewer includes:

a flash memory array management module, configured to convert, on a basis of organizational information of a flash memory array device, a logical address of a data read/write request coming from a client into a physical address of the flash memory array device and convert, according to the physical address, an original device read/write request into a device read/write request directed at the flash memory array device, where the device read/write request directed at the flash memory array device arrives at the flash memory array device via a network.

Preferably, the application server further includes: an access interface module, configured to implement communications between the flash memory array device and the flash memory array management module via a network so that the device read/write request arrives at the flash memory array device via the flash memory array management module and the access interface nodule.

Preferably, the flash memory array management module runs on a server or a server cluster.

Preferably, the flash memory array management module includes: a flash memory virtualization submodule, configured to virtualize and manage the flash memory array device to obtain the organizational information of the flash memory array device.

Preferably, the flash memory virtualization submodule is specifically configured to stripe data stored in a flash memory chip of the flash memory array device to obtain corresponding stripe information.

Preferably, the data read/write request coming from a client is a TCP/IP data packet; the application server further includes: a format converting module, configured to extract a Small Computer System Interface (SCSI) command from the TCP/IP data packet and send the SCSI command to the flash memory array management module.

In another aspect, embodiments of the present disclosure further disclose an application server, including:

a flash memory array management module, configured to convert, on a basis of organizational information of a flash memory array device, a logical address of a data read/write request coming from a client into a physical address of the flash memory array device and convert, according to the physical address, an original device read/write request into a device read/write request directed at the flash memory array device, where the device read/write request directed at the flash memory array device arrives at the flash memory array device via a network.

Preferably, the application server further includes: an access interface module, configured to implement communications between the flash memory array device and a flash memory virtualization submodule via a network so that the device read/write request arrives at the flash memory array device via the flash memory array management module and the access interface module.

Preferably, the flash memory array management module runs on a server or a server cluster.

Preferably, the flash memory array management module includes: a flash memory virtualization submodule, configured to virtualize and manage the flash memory array device to obtain the organizational information of the flash memory array device.

Preferably, the flash memory virtualization submodule is specifically configured to stripe data stored in a flash memory chip of the flash memory array device to obtain corresponding stripe information.

Preferably, the data read/write request coming from a client is a TCP/IP data packet; the application server further includes: a format converting module, configured to extract a Small Computer System Interface (SCSI) command from the TCP/IP data packet and send the SCSI command to the flash memory array management module.

In still another aspect, embodiments of the present disclosure further disclose a flash memory access method, including:

converting, by an application server on a basis of organizational information of a flash memory array device, a logical address of a data read/write request coming from a client into a physical address of the flash memory array device, and converting, according to the physical address, an original device read/write request into a device read/write request directed at the flash memory array device; and

sending, by the application server, the device read/write request to the flash memory array device via a network.

Preferably, the organizational information of the flash memory array device is obtained according to virtualization and management of the flash memory array device.

Preferably, the method further includes: receiving, by the application server via network, postback data sent by the flash memory array device after completion of data read/write, and returning the postback data to the client according to the logical address.

In still another aspect, embodiments of the present disclosure further disclose a computer program, including a computer-readable code, where the foregoing flash memory access method is executed when the computer-readable code runs on a computer.

In still another aspect embodiment of the present disclosure further disclose a computer-readable medium, in which the foregoing computer program is stored.

Compared with the prior art, embodiments of the present disclosure include following advantages.

In the embodiments of the present disclosure, a structure of a solid state disk is virtualized to be a flash memory device and a corresponding FTL logic, where the FTL logic is stored at a server, and the flash memory device is organized into a form of a flash memory array device. Communications may be implemented between the flash memory array device and the application server via network.

Firstly, communications may be implemented between the flash memory array device and the application server via network, which can save a general interface between a solid state disk and an application server in the existing scheme, and can allow the flash memory array device to be more easily integrated onto a storage network.

Secondly, a narrow solid state disk device is extended to be the field of broad flash memory storage area network. With development of 10 Gigabit Ethernet, as an IP storage network, the present disclosure has a better prospect.

Thirdly, the FTL logic is not a firmware inside a flash memory device anymore, and is uninstalled from the flash memory device and runs as a server application.

Fourthly, it is easier to expand storage capacity as long as quantity of flash memory chips in the flash memory array device is controlled and an FTL server is configured.

Fifthly, flash memory chips in the flash memory array device may also be organized to be a disk cluster to give full play to advantages of large capacity of disk cluster and low cost.

### BRIEF DESCRIPTION OF THE DRAWINGS

FIG. 1 is a schematic structural diagram of an existing network storage system for use in solid state disk,

FIG. 2 is a structural diagram of a network storage system for use in flash memory according to Embodiment I of the present disclosure;

FIG. 3 is a structural diagram of a network storage system for use in flash memory according to Embodiment II of the present disclosure,

FIG. 4 is a schematic diagram of an organizational structure of a flash memory array device 301 according to an embodiment of the present disclosure; and

FIG. 5 is a flowchart of a flash memory access method according to an embodiment of the present disclosure.

### DETAILED DESCRIPTION

To make the foregoing objectives, features, and advantages of the present disclosure more apparent and lucid, the following further describes in detail the present disclosure with reference to the accompanying drawings and embodiments.

### System Embodiment I

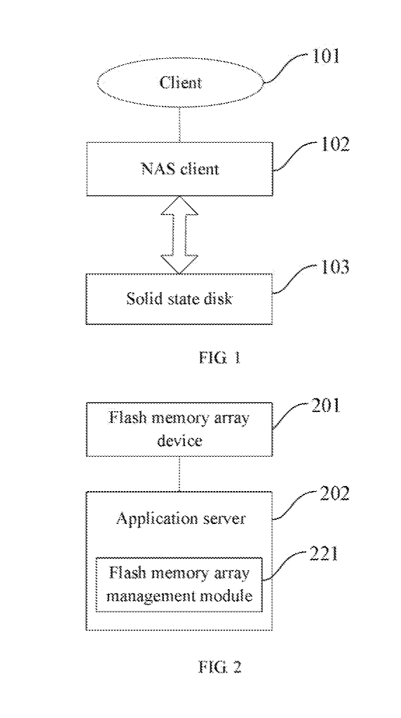

Referring to FIG. 2, FIG. 2 shows a structural diagram of a network storage system for use in flash memory according to Embodiment I of the present disclosure, specifically including: a flash memory array device 201 and an application server 202, where the application server 202 specifically may include a flash memory array management module 221.

The flash memory array management module 221 is specifically configured to convert, on a basis of organizational information of the flash memory array device, a logical address of a data read/write request coming from a client into a physical address of the flash memory array device and convert, according to the physical address, an original device read/write request into a device read/write request directed at the flash memory array device, where the device read/write request directed at the flash memory array device arrives at the flash memory array device via a network.

In the embodiments of the present disclosure, the structure of a solid state disk is virtualized to be a flash memory device and a corresponding, FTL (Flash Transfer Layer) logic, where the FTL logic is stored at a server, and the flash memory device is organized to be the form of the flash memory array device 201. Different from a solid state disk whose capacity is limited, the capacity of the flash memory array device 201 may be flexibly set up by those skilled in the art according to actual needs. In addition, communications may be implemented between the flash memory array device 201 and the application server 202 via network. Specifically, the device read/write request directed at the flash memory array device 201 may be transmitted via network without a general interface. Therefore, the embodiments of the present disclosure can increase convenience for network storage.

Flash Memory Array Management Module 221

The flash memory array management module 221 may acquire organizational information of the flash memory array device 201 and provide information such as block data capacity. The flash memory array management module 221 may have functions such as address mapping, garbage recycling and wear leveling, etc.

Taking address mapping as an example, the flash memory array management module 221 may maintain an address mapping table, where the address mapping table may contain a mapping relation from a logical address to a physical address of a flash memory chip in this way, after a data read/write request coming from a client is received, the logical address of the data read/Write request may be converted into the physical address of a flash memory chip in the flash memory array device by looking up the address mapping table, and an original device read/write request may be converted into a device read/write request directed at the flash memory array device 201 according to the physical address. In the same way, the flash memory array management module 221 may also return postback data after completion of data read/write to the client according to the logical address.

The flash memory array management module 221 may run on a server or a server cluster. Compared to an existing scheme where the FTL logic is implemented on a solid state disk, in the embodiments of the present disclosure, implementation of the FTL logic will not be limited by hardware resources anymore; and the FTL logic runs on the server or the server cluster, which can reduce hardware load of the FTL logic. In concrete implementation, the server may provide powerful processing capacity and cache host data of the address mapping table and the client by virtue of a huge RAM (Random Access Memory) or a buffer.

As can be seen, the foregoing method for running the FTL logic on a server or a server cluster has following advantages:

firstly, the address mapping table may reside in the server, which can improve convenience for flash transfer;

secondly, conditions of a UPS (Uninterruptible Power Supply) are provided, under which it is easier to process power failure events;

thirdly, write operation for mapping information may be reduced into once per power cycle in frequency, which makes flash transfer become easier and provides more efficient caching algorithms; and

fourthly, when a server cluster is used, it is possible to give full play to advantages of the server cluster, such as good extendability, good stability and good redundancy.

To sum up, the embodiments of the present disclosure have following advantages;

Firstly, communications may be implemented between the flash memory array device 201 and the application server via network, which can save a general interface between the solid state disk and the application server, and can allow the flash memory array device 201 to be more easily integrated onto a storage network.

Secondly, a narrow solid state disk device is extended to be the field of broad flash memory storage area network. With development of 10 Gigabit Ethernet, as an IP storage network, the present disclosure has a better prospect.

Thirdly, the FTL logic is not a firmware inside a flash memory device anymore, and is uninstalled from the flash memory device and runs as a server application.

Fourthly, it is easier to expand storage capacity as long as quantity of flash memory chips in the flash memory array device 201 is controlled and an FTL, server is configured.

Fifthly, flash memory chips in the flash memory array device 201 may be organized to be a disk cluster to give full play to advantages of large capacity of disk cluster and low cost.

### System Embodiment II

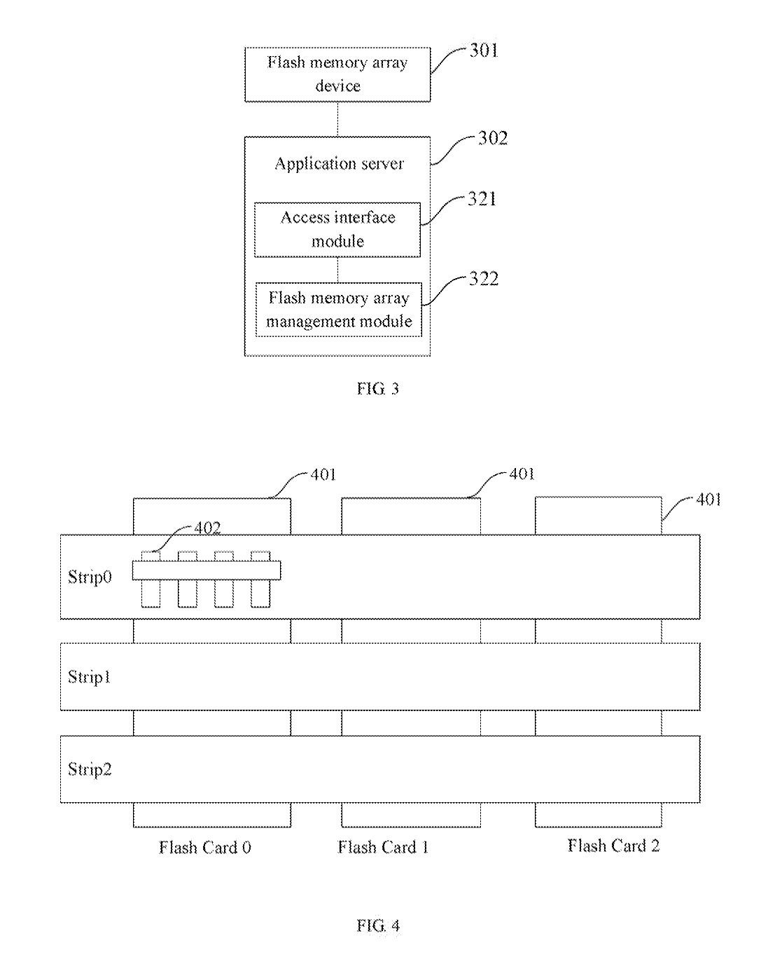

Referring to FIG. 3, FIG. 3 illustrates a structural diagram of a network storage system for use in flash memory according to Embodiment II of the present disclosure, specifically including, a flash memory array device 301 and an application server 302, where the application server specifically may include an access interface module 321 and a flash memory array management module 322.

The access interface module 321 is configured to implement communications between the flash memory array device 301 and the flash memory array management module 322; and

the flash memory array management module 322 is configured to convert, on a basis of organizational information of the flash memory array device 301, a logical address of a data read/write request coming from a client into a physical address of the flash memory array device and convert, according to the physical address, an original device read/mite request into a device read/write request directed at the flash memory array device 301, where the device read/write request arrives at the flash memory array device 301 via the flash memory array management module 322 and the access interface module 321.

Detailed description of the foregoing modules is made hereinafter,

Flash Memory Array Device 301

In practical application, the flash memory array device 301 is a physical circuit board corresponding, to a flash memory chip set. Taking the flash memory array device 301 corresponding to a NAND FLASH chip set as an example, the flash memory array device 301 shall have powerful NAND FLASH drive capability and can concurrently drive multiple NAND FLASH channels.

Furthermore, to implement communications with the server, the flash memory array device 301 also shall have network data access capability. Specifically, communications may be implemented between the flash memory array device 301 and the server via network, where the network herein specifically may include: an IP (Internet Protocol) network or an FC (Fiber Channel) network.

Access Interface Module 321

The access interface module 321 may be configured to implement communications between the flash memory array device 301 and the flash memory virtualization submodule 322. Supposing the flash memory array device 301 is positioned in a remote machine room, the access interface module 321 at the server may implement communications with flash memory chips in the flash memory array device 301 via the IP network or the FC network. Specifically, the access interface module 321 may package a device read/write request into a TCP/IP data packet in the form of an SCSI (Small Computer System Interface) and transmit the TCP/IP data packet to the flash memory array device 301 via the IP network to complete a read/write operation on a flash memory chip according to the device read/write request.

Flash Memory Array Management Module 322

The flash memory array management module 322 may convert an original device read/write request into a device read/write request directed at the flash memory array device 301, where a transmission path for the device read/write request may be as below: the client-the flash memory array management module 322—the access interface module 321—the flash memory array device 301.

In the same way, the flash memory may management module 322 may also return postback data after completion of data read/write to the client according to the logical address, where a transmission path for the postback data after completion of data read/write specifically may include: the flash memory array device 301—the access interface module 321—the flash memory array management module 322—the client.

In a preferred embodiment of the present disclosure, the flash memory array management module 322 may further include:a flash memory virtualization submodule, configured to virtualize and manage the flash memory array device 301 to obtain organizational information of the flash memory array device 301 so that the organizational information of the flash memory array device 301 is transparent to the flash memory array management module 322 and the flash memory array management module 322 only needs to work on the flash memory virtualization submodule without focusing on any organization detail. Therefore, flash transfer efficiency can be improved.

In a preferred embodiment of the present disclosure, the flash memory virtualization submodule may be specifically configured to stripe data stored in a flash memory chip and provide stripe information for the flash memory array management module. A piece of continuous data in a flash memory chip may be divided into a plurality of parts by striping, which are respectively stored in different stripes in this way, different stripes of data may be accessed simultaneously by multiple device read/write requests without causing read/write conflict, and the maximum I/O (Input/Output) concurrent capability may be obtained when sequential access is required for the data so that good performance can be obtained.

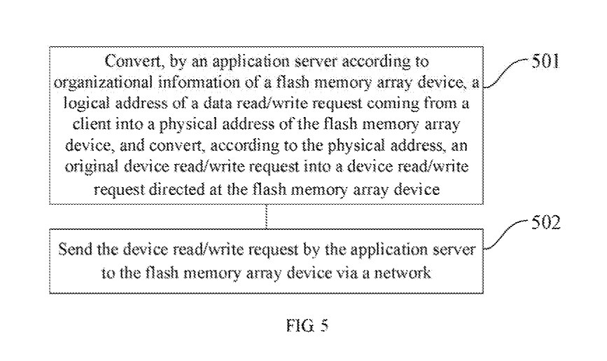

Referring to FIG. 4 which illustrates a schematic diagram of an organizational structure of a flash memory array device 301 according to an embodiment of the present disclosure, where the flash memory array device 301 specifically may include: a Flash Card 0, a Flash Card 1 and a Flash Card 2, where each Flash Card may further include a plurality of bare chips, each bare chip may further include multiple blocks 402, FIG. 4 shows that continuous data in each Flash Card 401 may be divided into a plurality of parts and a part of data in three Flash Cards 401 is jointly stored in a corresponding stripe, for example, the stripe 1 may simultaneously store a part of data in the Flash Card 0, the Flash Card 1 and the Flash Card 2, and the stripe 1 in FIG. 4 covers four blocks 402 in the Flash Card 0. It is understood that the stripe in FIG. 4 is merely exemplary, and the depth and the width of the stripe are not limited in the embodiments of the present disclosure.

Based on the organizational structure of the flash memory array device 301, the stripe may be a basic operating unit in the FTL logic. In view of a fact that a flash memory chip includes three basic operations: a reading operation, a programming operation and an erasing operation, the flash memory virtualization submodule may provide APIs (Application Program Interfaces) of the three basic operations for the flash memory array management module 322 so that the flash memory array management module 322 controls the flash memory array device 301 through these APIs. A particle size of these APIs may be a stripe. For example, supposing the flash memory array management module 322 is intended to erase a certain block, a corresponding data read/write request may be parsed by the flash memory virtualization submodule and divided into operation for erasing a plurality of small physical blocks. A corresponding addressing process specifically may include: firstly, searching for a flash memory chip, secondly, acquiring a bare chip number in the flash memory chip, and finally, executing an erasing command for a single block in the bare chip.

Referring to Table 1, Table 1 shows an addressing structure of a flash memory virtualization submodule according to the embodiments of the present disclosure, where a flash memory chip relates to an interface between the flash memory virtualization submodule and the flash memory chip. From a network level, the interface maybe an IP network, in other words, in the embodiments of the present disclosure, an IP address may be used for addressing of a particular flash memory chip. Further, in an addressing process, an address of a bare chip may be a number of a bare chip in a flash memory chip; an address of a block may be a number of a block in a bare chip, which generally includes plane information; and an address of a page may be offset of a page in a block.

TABLE 1

| | | | |
|---|---|---|---|
| Flash memory chip | Bare chip | Block | Page |

In a preferred embodiment of the present disclosure, the data read/write request coming from a client may be a TCP/IP data packet; the application server 302 may further include; a format converting module, configured to extract a Small Computer System Interface (SCSI) command from the TCP/IP data packet and send the SCSI command to the flash memory array management module,

### Application Server Embodiments

The present disclosure further provides embodiments of an application server, specifically including:

a flash memory array management module, configured to convert, on a basis of organizational information of a flash memory array device, a logical address of a data read/write request coming from a client into a physical address of the flash memory array device and convert, according to the physical address, an original device read/write request into a device read/write request directed at the flash memory array device, where the device read/write request directed at the flash memory array device arrives at the flash memory array device via a network.

In a preferred embodiment of the present disclosure, the application server may further include: an access interface module, configured to implement communications between the flash memory array device and the flash memory array management module via a network so that the device read/write request may arrive at the flash memory array device via the flash memory array management module and the access interface module.

In a preferred embodiment of the present disclosure, the flash memory array management module may run on a server or a server cluster.

In another preferred embodiment of the present disclosure, the flash memory array management module may further include: a flash memory virtualization submodule configured to virtualize and manage the flash memory array device to obtain organizational information of the flash memory array device.

In still another preferred embodiment of the present disclosure, the flash memory virtualization submodule may be specifically configured to stripe data stored in a flash memory chip to obtain corresponding stripe information.

In still another preferred embodiment of the present disclosure, the data read/write request coming from a client may be a TCP/IP data packet; the application server further includes: a format converting module, configured to extract a Small Computer System interface (SCSI) command from the TCP/IP data packet and send the SCSI command to the flash memory array management module.

### Access Method Embodiments

Referring to FIG. 5 which illustrates a flowchart of a flash memory access method according to an embodiment of the present disclosure, specifically including:

Step 501: converting, by an application server according to organizational information of a flash memory army device, a logical address of a data read/write request coming from a client into a physical address of the flash memory array device, and converting, according to the physical address, an original device read/write request into a device read/write request directed at the flash memory array device; and

Step 502: sending the device read/mite request by the application server to the flash memory array device via a network.

In a preferred embodiment of the present disclosure, the organizational information of the flash memory array device may be obtained according to virtualization and management of the flash memory array device.

In still another preferred embodiment of the present disclosure, the method may further include: receiving, by the application server, postback data sent by the flash memory array device after completion of data read/write, and returning the postback data to the client according to the logical address.

In still another preferred embodiment of the present disclosure, the data read/write request coming from a client may be a TCP/IP data packet, the method may further include: extracting a Small Computer System Interface (SCSI) command from the TCP/IP data packet, converting a logical address corresponding to the SCSI command into a physical address of the flash memory array device according to organizational information of the flash memory array device, and converting, according to the physical address, an original device read/write request into a device read/write request directed at the flash memory array device.

Method embodiments are basically similar to system embodiments, thus description of method embodiments are relatively simple, and reference can be made to the description of the system embodiments for relevant parts.

The embodiments in the specification are described in a progressive manner. Each embodiment is focused on difference from other embodiments. And cross reference is available for identical or similar parts among different embodiments.

The embodiments of the present disclosure are described with reference to flowcharts and/or block diagrams according to the method, terminal equipment (system) and computer program product of the embodiments of the present disclosure. It is to be understood that each flow and/or block in the flowchart and/or block diagram as well as combination of flow and/or block in the flowchart and/or block diagram may be realized by computer program instructions. These computer program instructions may be provided for a general-purpose computer, a special-purpose computer, an embedded processor or processors of other programmable data processing terminal equipment to generate a machine, so as to generate an apparatus configured to implement designated functions in one or more flows of a flowchart and/or one or more blocks of a block diagram by means of instructions executed by a computer or a processor of other programmable data processing terminal equipment.

Those skilled in the art should realize that an embodiment among the embodiments of the present disclosure may be provided as a method, an apparatus or a computer program product. Therefore, the embodiments of the present disclosure may use forms of a full hardware embodiment, a full software embodiment, or an embodiment in combination of software and hardware aspects. Furthermore, the embodiments of the present disclosure may use forms of computer program products implemented on one or more computer storage media (including but not limited to a magnetic disk memory, a CD-ROM, an optical memory or the like) which includes a computer program code.

Based on the above, the present disclosure further provides a computer-readable recording medium having recorded thereon a program for executing the flash memory access method. The contents of the method embodiments may be referred to for specific contents of the flash memory access method, which are not unnecessarily described herein.

The computer-readable recording medium includes any mechanism for storing or transmitting information in a computer-readable form. For example, a machine-readable medium includes a read-only memory (ROM), a random access memory (RAM), a magnetic disk storage medium, an optical storage medium, a flash memory storage medium, propagating signals (for example, carrier signal, infrared signal, digital signal and so on) in electrical, optical, acoustical or other forms, etc.

These computer program instructions may also be stored in a computer-readable memory which can lead a computer or other programmable data processing equipment to work in a particular way so that instructions stored in the computer-readable memory may generate a manufactured product comprising a command device which can achieve functions designated in one or more flows of the flowchart and/or in one or more blocks of the block diagram.

These computer program instructions may also be loaded on a computer or other programmable data processing terminal equipment, to execute a series of operating steps on the computer or other programmable terminal equipment to generate treatments implemented by the computer, so that instructions executed on the computer or other programmable terminal equipment provide steps configured to implement designated functions in one or more flows of a flowchart and/or one or more blocks of a block diagram.

Although preferred embodiments of the embodiments of the present disclosure have been described, those skilled in the art may make additional alterations and modifications on these embodiments as soon as they know the basic creative concept. Therefore, the appended claims are intended to be interpreted as comprising preferred embodiments and all alterations and modifications falling within the scope of the embodiments of the present disclosure.

Finally it should be explained that a relational term (such as a first or a second) is merely intended to separate one entity or operation from another entity or operation instead of requiring or hinting any practical relation or sequence exists among these entities or operations. Furthermore, terms such as “comprise”, “include” or other variants thereof are intended to cover a non-exclusive “comprise” so that a process, a method, a merchandise or a terminal device comprising a series of elements not only includes these elements, but also includes other elements not listed explicitly, or also includes inherent elements of the process, the method, the merchandise or the terminal device. In the case of no more restrictions, elements restricted by a sentence “include a . . . ” do not exclude the fact that additional identical elements may exist in a process, a method, a merchandise or a terminal device of these elements.

The above describes in detail a network storage system for use in flash memory, an application server and a flash memory access method provided by the present disclosure, elaboration of the principle and the implementation of the present disclosure is made by using specific examples herein, and the description of the foregoing embodiments is merely intended to assist in understanding the method of the present disclosure and the core concept thereof, also, those of ordinary skill in the art may change, in accordance with the concept of the present disclosure, a concrete implementation and the scope of the present disclosure. In conclusion, the specification shall be not interpreted as restriction on the present disclosure.

What is claimed is:

1. A network storage system for use in flash memory, comprising: a flash memory array device and an application server, wherein the application server comprises:
memory having instructions stored thereon;
a processor configured to execute the instructions to perform operations, comprising:
converting, on a basis of organizational information of the flash memory array device, a logical address of a data read/write request coming from a client into a physical address of the flash memory array device and converting, according to the physical address, an original device read/write request into a device read/write request directed at the flash memory array device, wherein the device read/write request directed at the flash memory array device arrives at the flash memory array device via a network.

2. The system of claim 1, wherein the processor is further configured to execute the instructions to perform operation of: implementing communications between the flash memory array device and the application server via a network so that the device read/write request arrives at the flash memory array device.

3. The system of claim 1, wherein the application server is a server or a server cluster.

4. The system of claim 1, wherein the operation of converting, on a basis of organizational information of the flash memory array device, a logical address of a data read/write request coming from a client into a physical address of the flash memory array device and converting, according to the physical address, an original device read/write request into a device read/write request directed at the flash memory array device comprises virtualizing and managing the flash memory array device to obtain the organizational information of the flash memory array device.

5. The system of claim 4, wherein the operation of virtualizing and managing the flash memory array device to obtain the organizational information of the flash memory array device comprises striping data stored in a flash memory chip of the flash memory array device to obtain corresponding stripe information.

6. The system of claim 1, wherein the data read/write request coming from a client is a TCP/IP data packet; the processor is further is configured to execute the instructions to perform operation of: extracting a small computer system interface command from the TCP/IP data packet.

7. An application server, comprising:
a memory having, instructions stored thereon;
a processor configured to execute the instructions to perform operations, comprising:
converting, on a basis of organizational information of a flash memory array device, a logical address of a data read/write request coming from a client into a physical address of the flash memory array device and converting, according to the physical address, an original device read/write request into a device read/write request directed at the flash memory array device, wherein the device read/write request directed at the flash memory array device arrives at the flash memory array device via a network.

8. The application server of claim 7, wherein the processor is further configured to execute the instructions to perform operation of: implementing communications between the flash memory array device and the application server via a network so that the device read/write request arrives at the flash memory array device.

9. The application server of claim 7, wherein the application server is a server or a server cluster.

10. The application server of claim 7, wherein the operation of converting, on a basis of organizational information of the flash memory array device, a logical address of a data read/write request coming from a client into a physical address of the flash memory array device and converting, according to the physical address, an original device read/write request into a device read/write request directed at the flash memory array device comprises: virtualizing and managing the flash memory array device to obtain the organizational information of the flash memory array device.

11. The application server of claim 10, wherein the operation of virtualizing and managing the flash memory array device to obtain the organizational information of the flash memory array device comprises: striping data stored in a flash memory chip of the flash memory array device to obtain corresponding stripe information.

12. The application server of claim 7, wherein the data read/write request coming from a client is a TCP/IP data packet: the processor is further configured to perform operation of: extracting a small computer system interface command from the TCP/IP data packet.

13. A flash memory access method, comprising:
converting, by an application server on a basis of organizational information of a flash memory array device, a logical address of a data read/write request coming from a client into a physical address of the flash memory array device, and converting, according to the physical address, an original device read/write request into a device read/write request directed at the flash memory array device; and
sending, by the application server, the device read/write request to the flash memory array device via a network.

14. The method of claim 11, wherein the organizational information of the flash memory array device is obtained according to virtualization and management of the flash memory array device.

15. The method of claim 11, further comprising; receiving, by the application server via a network, postback data sent by the flash memory array device after completion of data read/write, and returning the postback data to the client according to the logical address.

16-17. (canceled)

18. The system according to claim 2, wherein implementing communications between the flash memory array device and the application server via a network comprises;
implementing communications between the flash memory array device and the application server via an Internet protocol network or an Fiber Channel network.

19. The application server according to claim 7, wherein implementing communications between the flash memory array device and the application server via a network comprises:
implementing communications between the flash memory array device and the application server via an Internet protocol network or an Fiber Channel network.
